(19) United States
(12) Patent Application Publication
(10) Pub. No.: US 2009/0128781 A1
(43) Pub. Date: May 21, 2009

(54) LED multiplexer and recycler and micro-projector incorporating the Same

(76) Inventor: Kenneth Li, Castaic, CA (US)

Correspondence Address: FULBRIGHT & JAWORSKI, LLP, 666 FIFTH AVE, NEW YORK, NY, 10103-3198, US

(21) Appl. No.: 12/321,471

(22) Filed: Jan. 20, 2009

Related U.S. Application Data
(63) Continuation-in-part of application No. 11/818,308, filed on Jun. 13, 2007.
(60) Provisional application No. 60/813,186, filed on Jun. 13, 2006.
(60) Provisional application No. 60/814,605, filed on Jun. 16, 2006.
(60) Provisional application No. 60/830,946, filed on Jul. 13, 2006.
(60) Provisional application No. 60/842,324, filed on Sep. 5, 2006.
(60) Provisional application No. 60/848,429, filed on Sep. 28, 2006.
(60) Provisional application No. 60/855,330, filed on Oct. 30, 2006.

(51) Int. Cl. G02B 27/18; F21V 7/04; F21V 13/02; G03B 21/28

(52) U.S. Cl. 353/20; 362/235; 362/555; 353/81; 362/551; 362/553

(57) ABSTRACT

A micro-projector comprises an LED layer, a light pipe coupled to the LED, a LCOS panel, a projection lens, a PBS, an aperture layer coupled to the output end of the light pipe which has a transmissive opening for transmitting a portion of the light output and a reflective surface for reflecting the remaining portion of the light output toward the input end of the light pipe. Thus, the remaining portion of the light output is recycled back to the LED to increase the brightness of the light output of the LED. The micro-projector also comprises a reflective polarizer disposed between the light pipe and the aperture layer for transmitting the light output of a predetermined polarization and reflecting other polarization of the light output, thereby recycling unused polarization of the light output back to the LED to increase the brightness of the light output of the LED.

### CROSS-REFERENCE TO RELATED APPLICATIONS

This application claims the benefit of U.S. Provisional Application Ser. No. 61/011,458 filed Jan. 17, 2008, U.S. Provisional Application Ser. No. 61/130,981 filed Jun. 4, 2008, U.S. Provisional Application Ser. No. 61/130,953 filed Jun. 4, 2008, U.S. Provisional Application Ser. No. 61/137,895 filed Aug. 4, 2008, U.S. Provisional Application Ser. No. 61/200,764 filed Dec. 3, 2008, U.S. Provisional Application Ser. No. 61/203,503 filed Dec. 23, 2008, and U.S. Provisional Application Ser. No. 61/203,950 filed Dec. 30, 2008, each of which is incorporated by reference in its entirety; this application is also a continuation-in-part application of Ser. No. 11/818,308 filed Jun. 13, 2007, which claims the benefit of U.S. Provisional Application Ser. No. 60/813,186, filed Jun. 13, 2006, U.S. Provisional Application Ser. No. 60/814,605, filed Jun. 16, 2006, U.S. Provisional Application Ser. No. 60/830,946, filed Jul. 13, 2006, U.S. Provisional Application Ser. No. 60/842,324, filed Sep. 5, 2006, U.S. Provisional Application Ser. No. 60/848,429, filed Sep. 28, 2006, and U.S. Provisional Application Ser. No. 60/855,330, filed Oct. 30, 2006, each of which is incorporated herein by reference in its entirety.

### TECHNICAL FIELD OF INVENTION

This invention relates to systems and methods for multiplexing output of LEDs, particularly increasing the brightness of the multiplexed LED output through recycling and incorporating the same in a micro-projector.

### BACKGROUND

Light sources are used in all types of illumination applications. Typical light sources include but are not limited to arc lamps, halogens, fluorescent devices, microwave lamps, and Light Emitting Diodes (LEDs). Many applications require an illumination system with a high level of brightness in a small effective emitting area. This high level of brightness can be accomplished conventionally by adding more light sources. However, this can be both technologically impossible if there is a limited space for integrating light sources and economically unfeasible as it can be expensive to integrate and use multiple light sources. Accordingly, the present invention proceeds upon the desirability of increasing the brightness of a light source without increasing the number of the light source.

For example, micro-display based television (MDTV) has the potential of being low cost with large screen size. Traditional MDTVs are usually illuminated by arc lamps. Although this light source is the brightest at the lowest cost, the need to split the white light into 3 colors and the short lifetime make is less desirable. With advances in LED technology, the use of LED as the light source in MDTVs has to be considered to capture the long life feature of LEDs and other benefits such as instant ON. However, at the present time, LEDs are not bright enough for low cost application using small imaging panels or with larger screens. LED recycling scheme has been used to enhance the brightness of the light source, see U.S. Pat. No. 6,869,206 issued to Zimmerman et al. However, Zimmerman et al. describes enclosing the LEDs in a light-reflecting cavity with one light output aperture. Also, U.S. Pat. No. 6,144,536 issued to Zimmerman et al. describes a fluorescent lamp having a glass envelope with a phosphor coating enclosing a gas filled hollow interior. A portion of the light generated by the phosphor coating is recycled back to the phosphor coating. The present invention proceeds upon the desirability of providing a recycling device that can be coupled to one or more LEDs to increase the useable brightness of the LED by recycling efficiently such that smaller panels can be used or large screens can be illuminated with sufficient brightness.

For example, LEDs are one type of light source used in many illumination applications such as general lighting, architectural lighting, and more recently in projection televisions. When used in projection televisions for example, LEDs must emit light in a small effective emitting area at a high brightness level in order to provide the requisite high light output on the television screen. Specifically, the LEDs must provide an intense and bright light as measured in lumens at a small and solid angle in a small emitting area to be useful in projection televisions.

Although there had been tremendous advancement in the light emitting diode (LED) development, the output brightness of currently available LEDs is still not sufficient for most projection applications. Various methods had been proposed used to combine LED's with primary colors and recycling of output light to increase brightness. However, most of them these methods involve utilizing expensive components and/or results in a large, bulky device which greatly limits their applications. Therefore, the present invention proceeds upon the desirability of providing low cost LED multiplexer with recycling that solves these problems.

With the advancement in information transfer, displaying of images has become an important means of communication in the marketplace. For example, although portable electronic devices, such mp3 players, cell phones, audio and/or video players, portable digital assistants (PDAs), keep decreasing in size and price, the requirement for large display area in these portable electronic devices remains unchanged. Accordingly, the screen size now limits the size of these portable electronic devices and incorporating micro-projectors into the portable electronic devices would be highly desirable, but their high cost prevent such full-scale incorporation. However, currently available micro-projectors have architectures that are simply reduced from standard projectors, and as a result, the cost remains too high to be incorporated into low cost portable electronic devices. The most important parameters for any component to be embedded in these portable electronic devices are size and cost. Accordingly, the present invention proceeds upon the desirability of providing a low cost micro-projectors with integrated multiplexer/recycler in accordance with an embodiment of the present invention.

Therefore, the present invention proceeds upon the desirability of providing a low cost LED multiplexer with recycling to increase the brightness of LEDs while maintaining the size of the LED multiplexer small. This permits the LED multiplexer/recycler of the present invention to be readily incorporated into low cost micro-projectors for use in low cost portable electronic devices. That is, the micro-projector of the present invention incorporates the LED multiplexer with recycling to advantageously provide a small, low cost, versatile, and bright LED based illumination system which can be readily integrated with the portable electronic devices. The LED based illumination system can also multiplex colors to provide both colored pixel displays and time sequential displays.

### SUMMARY OF THE INVENTION

Therefore, it is an object of the present invention to provide a LED multiplexer with recycling to increase the brightness of the LEDs.

Another object of the present invention is to provide a small, low cost LED multiplexer with recycling, which can be readily incorporated into a micro-projector

A further object of the present invention is to provide a light pipe based RGB multiplexer with recycling for efficiently combining LED's with Red, Green, and Blue outputs and recycling the output to increase the brightness.

A still another object of the present invention is to provide a wafer scale LED illumination system extendible into a wafer scale LED projector system. That is, a complete illumination and projection system can be fabricated in a wafer form and cut into individual system at the very end.

A yet another object of the present invention is to provide a low cost micro-projector for use in portable electronic device, which incorporates the LED multiplexer/recycler of the present invention.

In accordance with an exemplary embodiment of the present invention, a light multiplexer and recycler comprises an LED layer which has a plurality of LEDs, each emitting a light output. The light multiplexer and recycler further comprises an optics layer having an input end and an output end. The input end of the optics layer is coupled to the plurality of LEDs for multiplexing light output from the plurality of LEDs. An aperture layer is coupled to the output end of the optics layer which has a transmissive opening for transmitting a portion of the multiplexed light output to provide a single light output and a reflective surface for reflecting a remaining portion of the multiplexed light toward the input end of the optics layer. Thus, the remaining portion of the multiplexed light is recycled back to the plurality of LEDs to increase the brightness of the light output of the plurality of LEDs.

In accordance with an exemplary embodiment of the present invention, a micro-projector comprises an LED layer which has an LED emitting a light output. The micro-projector further comprises a light pipe having an input end and an output end where the input end of the light pipe is coupled to the LED. An aperture layer is coupled to the output end of the light pipe which has a transmissive opening for transmitting a portion of the light output and a reflective surface for reflecting the remaining portion of the light output toward the input end of the light pipe. Thus, the remaining portion of the light output is recycled back to the LED to increase the brightness of the light output of the LED. The micro-projector also comprises a reflective polarizer disposed between the light pipe and the aperture layer for transmitting the light output of a predetermined polarization and reflecting other polarization of the light output, thereby recycling unused polarization of the light output back to the LED to increase the brightness of the light output of the LED. The micro-projector further comprises a liquid crystal on silicon (LCOS) panel for receiving and reflecting the light output of a predetermined polarization, wherein the size of the transmissive opening substantially matches the size of the LCOS panel such that a face of the PBS coupling the LCOS panel is larger than the LCOS panel. In addition, the micro-projector comprises a projection lens for capturing the light output of the predetermined polarization from the LCOS panel to project an image.

In accordance with an exemplary embodiment of the present invention, a micro-projector comprises an LED layer that has an LED emitting a light output and also has a light pipe having an input end and an output end. The input end of the light pipe is coupled to the LED. The micro-projector further comprises a polarization beam splitter (PBS) with all surfaces polished to provide total internal reflection such that the PBS acts as a waveguide.

Various other objects, advantages and features of the present invention will become readily apparent from the ensuing detailed description, and the novel features will be particularly pointed out in the appended claims.

### BRIEF DESCRIPTION OF THE DRAWINGS

The following detailed description, given by way of example, and not intended to limit the present invention solely thereto, will best be understood in conjunction with the accompanying drawings in which like components or features in the various figures are represented by like reference numbers:

FIG. 1 is a cross-sectional view of a light pipe based light multiplexer and recycler in accordance with an exemplary embodiment of the present invention;

FIG. 2 shows a perspective view of the light pipe based light multiplexer and recycler of FIG. 1;

FIG. 3 is a perspective view of the output end of the light pipe coated with reflective coating except the transmissive opening in accordance with an exemplary embodiment of the present invention;

FIG. 4 is a perspective view of light pipe based light multiplexer and recycler of the present invention with a selectively coated thin glass plate attached to the input end of the light pipe in accordance with an exemplary embodiment of the present invention;

FIG. 5 is a cross-sectional view of the light multiplexer and recycler of the present invention using a light generating layer excited by external optical source in accordance with an exemplary embodiment of the present invention;

FIG. 6 is a cross-sectional view of the light multiplexer and recycler of the present invention of FIG. 5 where the light generating layer is coated directly on the external optical source in accordance with an exemplary embodiment of the present invention;

FIGS. 7(a)-(b) are cross-sectional view of a cavity housing the light generating layer and/or the external excitation light source in accordance with an exemplary embodiment of the present invention;

FIG. 8(a) is a cross-sectional view of the light multiplexer and recycler of present invention of FIG. 5 where the light generating layer comprises one or more different light generating material excited by a laser in accordance with an exemplary embodiment of the present invention;

FIG. 8(b) is a view of the light generating layer comprising three different light generating materials excited by a laser in accordance with an exemplary embodiment of the present invention;

FIGS. 9(a)-(c) are cross-sectional views of the light multiplexer and recycler of present invention of FIG. 5 where the light generating layer comprises one or more different light generating material excited by one or more lasers in accordance with an exemplary embodiment of the present invention;

FIG. 10 is a cross-sectional view of the light generating layer with a coating in accordance with an exemplary embodiment of the present invention;

FIG. 11 is a cross-sectional view of three cube prisms for multiplexing three colored lights from three different light generating materials to form a single output in accordance with an exemplary embodiment of the present invention;

FIG. 12 is a schematic diagram of wafer scale illumination systems and/or wafer scale projector systems in accordance with an exemplary embodiment of the present invention;

FIG. 13 is a schematic diagram of wafer scale light pipe based illumination systems and/or wafer scale light pipe based projector systems in accordance with an exemplary embodiment of the present invention;

FIG. 14 is a schematic diagram of wafer scale illumination systems and/or wafer scale projector systems in accordance with another exemplary embodiment of the present invention;

FIG. 15 is a cross-sectional view of the LED package with a cover glass in accordance with an exemplary embodiment of the present invention;

FIGS. 16-19 are cross-sectional views of the micro-projector in accordance with an exemplary embodiment of the present invention;

FIG. 20 is view of a face of a PBS which is reflective coated except for an opening for coupling the LCOS panel in accordance with an exemplary embodiment of the present invention;

FIG. 21 is a cross-sectional view of the micro-projector incorporating a DMD in accordance with an exemplary embodiment of the present invention; and

FIG. 22-26 are views of the light multiplexer and recycler in accordance with an exemplary embodiment of the present invention.

### DETAILED DESCRIPTION OF THE EMBODIMENTS

With reference to the figures, exemplary embodiments of the present invention are now described. These embodiments illustrate principles of the invention and should not be construed as limiting the scope of the invention.

In accordance with an exemplary embodiment of the present invention, a light multiplexer and recycler 1000 comprises a LED layer 1100 comprising a plurality of LEDs 1140. Each LED 1140 emits a light output to an optics layer 1200, such as a light pipe 1200. The optics layer 1200 has an input end 1210 and an output end 1220. The input end 1210 of the optics layer 1200 being coupled to the plurality of LEDs 1140 for multiplexing light output from the plurality of LEDs 1140. Additionally, the light multiplexer and recycler 1000 comprises an aperture layer 1500, such as a reflective coating 1500, coupled to the output end 1220 of the optics layer 1200. The aperture layer 1500 has a transmissive opening 1510 for transmitting a portion of the multiplexed light output to provide a single light output 1600 and a reflective surface for reflecting remaining portion of the multiplexed light toward the input end 1210 of the optics layer 1200, thereby recycling the remaining portion of the multiplexed light back to the plurality of LEDs 1140 to increase the brightness of the light output of the plurality of LEDs 1140. Preferably, a reflective layer 1400 covers the input end 1210 of the light pipe 1200 except areas 1410, 1420, 1430 of the input end 1210 of the light pipe where the plurality of LEDs 1140 are coupled such that the input end 1210 is reflective for all colors of light except areas 1410, 1420, 1430.

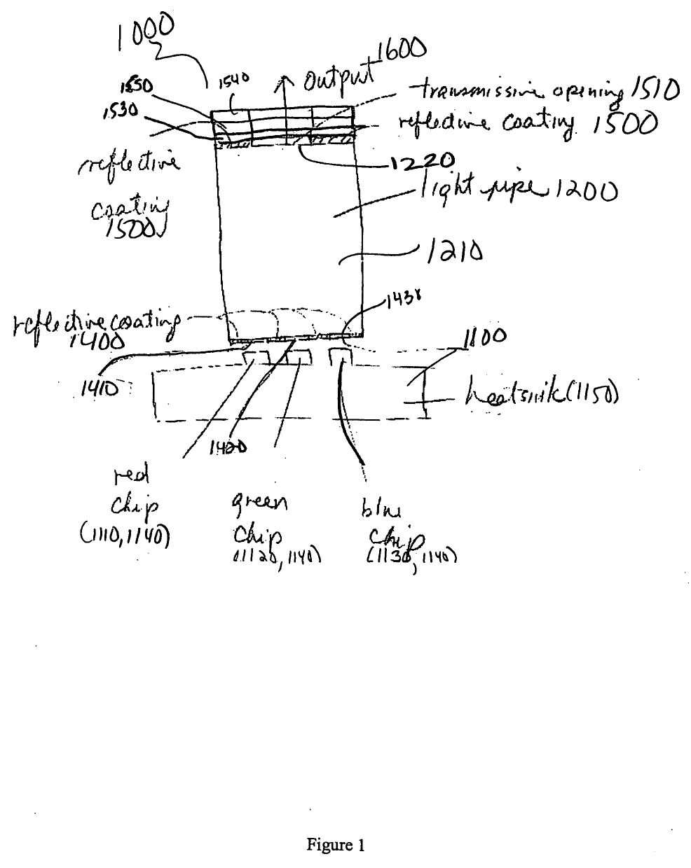

In accordance with an exemplary embodiment of the present invention, FIG. 1 shows a light pipe based light multiplexer and recycler 1000 comprising a LED layer 1110 comprising a plurality of LED chips 1140 mounted on a heat sink 1150 and an optics layer or light pipe 1200. The LED multiplexer and recycler 1000 multiplexes or combines the outputs of Red, Green, and Blue LED chips 1110, 1120, 1130 using the light pipe 1200 to produce a single output 1600. In accordance with an aspect of the present invention, the reflective layer 1400 is a reflective coating 1400 on the input end or surface 1210 of the light pipe 1200 such that the input end 1210 is reflective for all colors of light except areas of the input end or surface 1210 above or corresponding to the LED chips 1140. Additionally, the area 1410 of the input end 1210 of the light pipe 1200 above or corresponding to the red LED chip 1110 is coated with transmissive red coating that transmits the red light but reflects other colored lights, such as green and blue light. Similarly, the area 1420 of the input end 1210 of the light pipe 1200 above or corresponding to the green LED chip 1120 is coated with transmissive green coating that transmits green light but reflects other colored lights, such as red and blue light. The area 1430 of the input end 1210 above or corresponding to the blue LED chip 1130 is coated with transmissive blue coating that transmits blue light but reflects other colored lights, such as red and green light. Although only one red LED chip 1110, one green LED chip 1120, and one blue LED chip 1130 are shown in FIG. 1, it is understand that a plurality of red LED chips 1110, a plurality of green LED chips 1120, and a plurality of blued LED chips 1130 can be mounted on the heat sink 1150. Preferably, the output end or surface 1220 of the light pipe 1200 has reflective coating 1500 except in the area or transmissive opening 1510 of the output end or surface 1220 where the output 1600 is coupled.

When the red light from the red LED chips 1110 enters into the light pipe 1200, a portion or part of the red light will exit the light pipe through the transmissive opening 1510. The remaining portion or rest of the red light will be reflected back to the input end 1210 of the light pipe 1200 and be recycled. Similarly, when green light from green LED chips 1120 and blue light from blue LED chips 1130 enter into the light pipe 1200, portions of the green and red light exit the light pipe 1200 through the transmissive opening 1510 and the remaining portions of the green and red light are recycled.

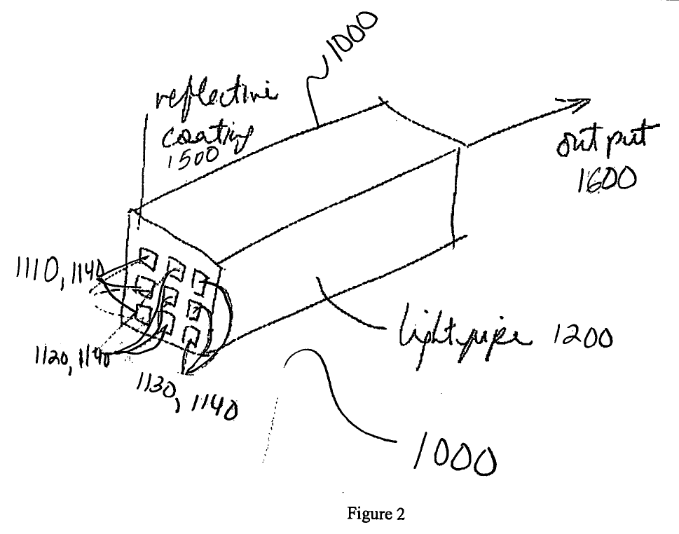

FIG. 2 shows a perspective view of the light multiplexer and recycler with nine LED chips 1140 of three different colors (red, green and blue) in accordance with an exemplary embodiment of the present invention. In practical applications, the number of LED chips 1140 and the colors emitted by the LED chips 1140 can be optimized to produce the desired outputs. The LED chips 1140 can be arranged in any M×N array (where M and N are both positive integers), such 3×3 array as shown in FIG. 2.

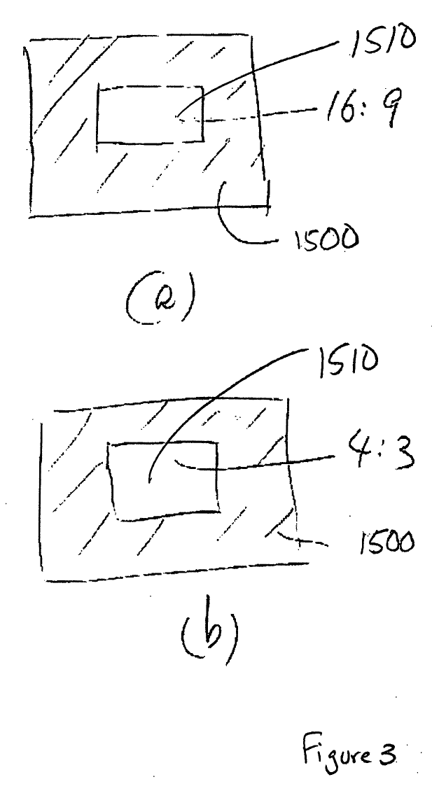

FIG. 3 shows two examples of the aperture layer 1500 comprising the transmissive or output opening 1510 at the output end 1220 of the light pipe 1200 surrounded by reflective coating 1510. The transmissive opening 1510 is smaller than the output end 1220 of the light pipe 1200. Also, the transmissive opening 1510 can have aspect ratios of 16:9 (FIG. 3(a)), 4:3 (FIG. 3(b)), or any other acceptable aspect ratios.

In accordance with an exemplary embodiment of the present invention, the transmissive opening 1510 is coated with a reflective coating 1530 that transmits a predetermined color of light, such as red light, and reflects all other color of light toward the input end 1210 of the light pipe 1200 for recycling. Preferably, the transmissive opening 1510 can be additionally coated with a reflective polarization coating 1540 or cover with a reflective polarization layer 1540 for transmitting the light output of a predetermined polarization, such as s-polarization or p-polarization, and reflecting the light output of all other polarization (i.e., unused polarization of light) for recycling. Alternatively, the transmissive opening 1510 is coated with the reflective polarization coating or covered with a reflective polarization layer 1540 without the reflective coating 1530. In accordance with an aspect of the present invention, the light multiplexer and recycler 1000 additionally includes a wave plate 1550 disposed between the reflective polarization layer 1540 and reflective coating 1530 or between the reflective polarization layer 1540 and the transmissive opening 1510. The wave plate 1550 rotates the polarization state of the light output and converts the unused polarization of light into the useful, predetermined polarization of light.

In accordance with exemplary embodiment of the present invention, the light multiplexer and recycler 1000 comprises a color wheel comprising a plurality of colored filters for transmitting colored light corresponding to the color filter and reflecting light of all other colors. That is, the reflective coating 1530 is replaced with a color wheel which covers the transmissive opening 1510 for selectively transmitting a different colors of light depending on which colored filter of the color wheel is covering the transmissive opening 1510.

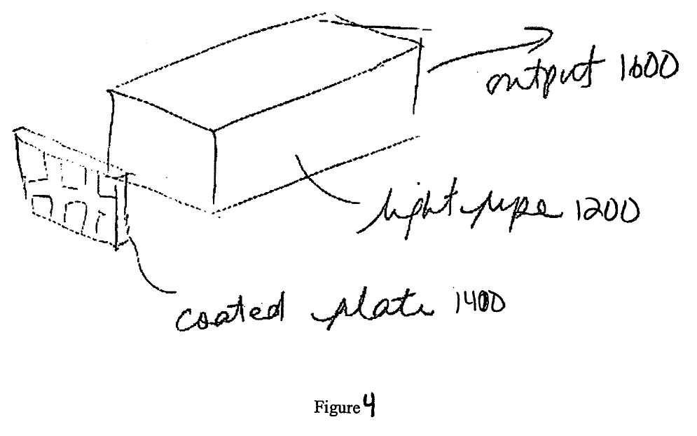

The exemplary embodiment of the present invention, as shown in FIGS. 1, 2, has the reflective coatings 1400, 1500 coated directly on the input and output ends 1210, 1220 of the light pipe 1200. This is highly efficient, but can be costly. Accordingly, in a low cost application, the reflective coatings 1400, 1500 can be done separately, such as using a selectively, reflectively coated thin glass plate 1400. A large glass plate can be selectively or patterned coated with a reflective coating and then cut to appropriate size to match the input end 1210 or output end 1220 of the light pipe 1200, as shown in FIG. 4. The patterned or selectively coated glass plate 1400 is attached to the light pipe 1200.

In accordance with an exemplary embodiment of the present invention, the light pipe 1200 can be one of the following: hollow light pipe, solid light pipe, straight light pipe, increasingly tapered light pipe, decreasingly tapered light pipe, compound parabolic concentrator, free form light pipe with its shape defined by equations, or totally free-form light pipe determined numerically or other means, or any suitable combination, such as straight hollow light pipe, a increasingly tapered solid light pipe. All of these various light pipes will be collectively referred to herein as the light pipe. Any reference to a light pipe includes any of the light pipes or combination of various light pipes set forth herein.

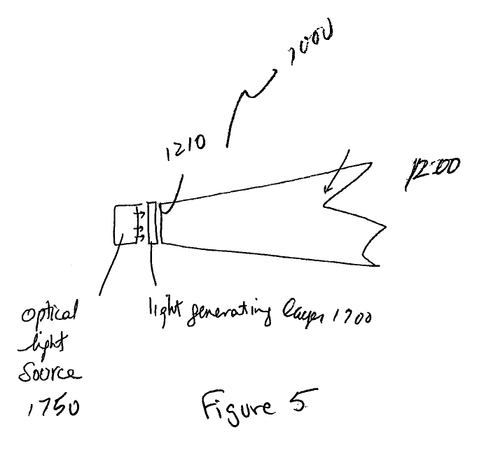

In accordance with an exemplary embodiment of the present invention, as shown in FIG. 5, the light multiplexer and recycler 1000, at the input side, comprises a light generating layer 1700 for emitting rays of light when excited by a light source 1750 and having a reflective surface. The input end 1210 of the light pipe 1120 being coupled to the light generating layer 1700 for multiplexing the rays of light from the light generating layer 1700 to provide a light output. As shown in FIG. 1, the light multiplexer and recycler 1000 at the output side, comprises the aperture layer 1500 coupled to the output end 1220 of the light pipe 1200 and having a transmissive opening 1510 for transmitting a portion of the light output and a reflective surface for reflecting remaining portion of the light output toward the light generating layer 1700 which reflects and recycles the remaining portion of light output back towards the transmissive opening 1510.

As noted herein, although not shown in FIG. 5, the light multiplexer and recycler 1000 comprising the light generating layer 1700, also comprises a light pipe 1200 with the output end 1220 partially or totally covered with the reflective coating 1530 and/or the reflective polarization layer 1540, and/or the wave plate 1550 to transmit light of predetermined color and/or polarization, and reflect/recycle all other unused color and/or polarization of light, as shown in FIG. 1. The input end 1210 of the light pipe 1200 is disposed in proximity to the light generating layer 1700 which is excited by external optical light sources 1750, such that the light emitted by the light generating layer 1700 is coupled into the light pipe 1200. Preferably, the light generating layer 1700 is also reflective such that light reflected from the output end 1220 of the light pipe 1200 is totally or partially reflected back to the output end 1220 of the light pipe 1200 from the reflective light generating layer 1700.

In accordance with an exemplary embodiment of the present invention, the light generating layer 1700 in proximity to the input end 1210 of the light pipe 1200 comprises one or more type of material compositions to emit rays of light having a plurality of wavelengths or colors. That is, the light generating layer 1700 can emit only one color of light or multiple colors of light depending on the material composition of the light generating layer 1700. Preferably, the various material compositions of the light generating layer 1700 are spatially distributed such that each area of the light generating layer 1700 emits rays of light of different color. The external excitation light source 1750 can be arc lamps, LEDs, lasers and the like, emitting light of single wavelength or multiple wavelengths (i.e., a single color or multiple colors). In accordance with an aspect of the present invention, the excitation wavelength(s) (i.e., the wavelengths of light emitted by the external excitation light source 1750 can be shorter than the wavelength(s) emitted by the light generating layer 1700. For example, a blue or UV light can be used to generate red, green, blue, or other colored light. Preferably, the light generating layer 1700 can be made of phosphor or other materials with the same properties as phosphor. Alternatively, the excitation wavelength(s) can also be longer than the wavelength(s) of the light generating layer 1700. For example, infrared light can be used to generate red, green, blue, or other colored light using non-linear crystals.

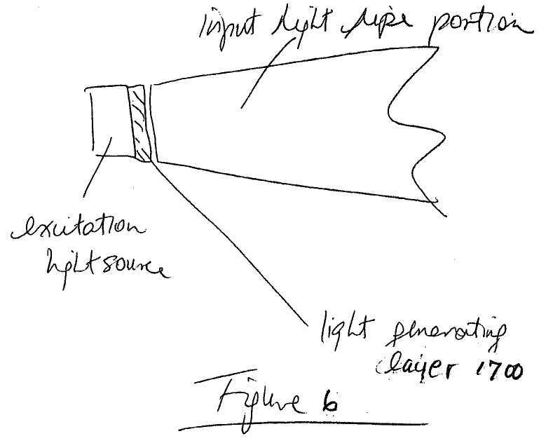

In accordance with an exemplary embodiment of the present invention, the light generating layer 1700 can be coated on the input end 1210 of the light pipe similar to the reflective coating 1400 in FIG. 1. Alternatively, the light generating layer 1700 can be coated on a sheet of transparent material, e.g. a glass plate, similar to the thin glass plate 1400 in FIG. 4, and placed in close proximity to the input end 1210 of the light pipe 1220, or coated directly on the excitation light source 1750 as shown in FIG. 6. For example, the phosphor materials can be coated directly on a blue or UV LED 1750, and the non-linear crystal materials can be coated directly on an infrared LED 1750. An example of a blue or UV LED 1750 is a light-emitting junction fabricated on GaN. An example of an infrared LED 1750 is light-emitting junction fabricated on GaAs.

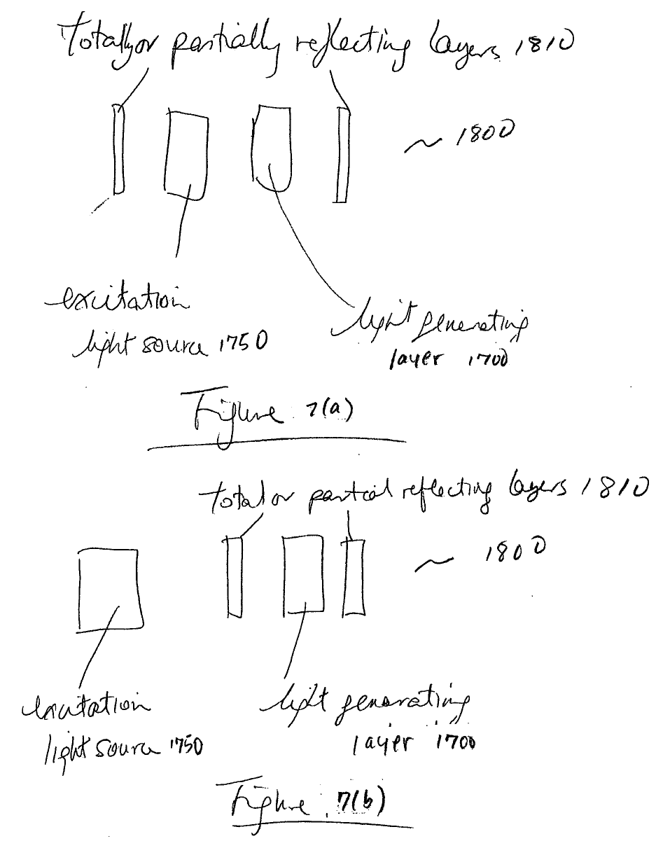

In accordance with an exemplary embodiment of the present invention, as shown in FIG. 7(b), the light generating layer 1700 is placed between total or partially reflecting layers 1810 in opposite sides of the light generating layer 1700 to form a cavity 1800, thereby enabling a smaller output angular distribution or reducing angular distribution of the light emitted by the light generating layer 1700. In accordance with an aspect of the present invention, both the excitation light source 1750 and the light generating layer 1700 are inside the cavity 1800, as shown in FIG. 7(a).

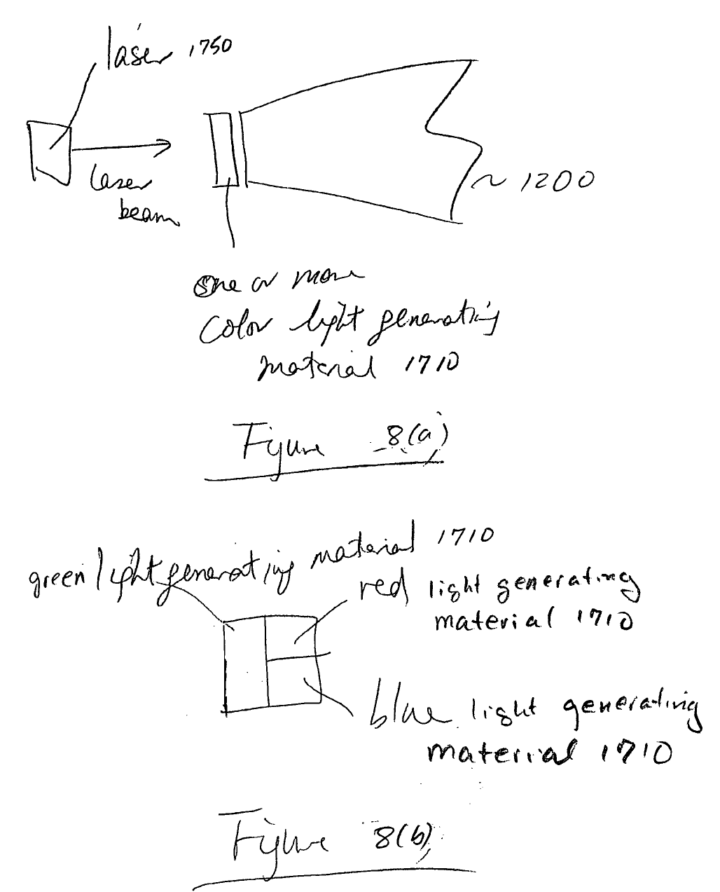

In accordance with an exemplary embodiment of the present invention, as shown in FIG. 8(a), the light generating layer 1700 comprises one or more different light generating materials 1710 (e.g., containing different colored phosphors) for emitting one or more colors of light when excited by a laser. The light generating materials can be arranged in a row, column, array or some predetermined pattern. For example, FIG. 8(b) shows a light generating layer 1700 with three different light generating materials 1710 (green, red and blue light generating materials 1710). Preferably, the laser is a diode laser. An example of a blue or UV laser is a laser fabricated using GaN materials. An example of an infrared laser is a laser fabricated using GaAs.

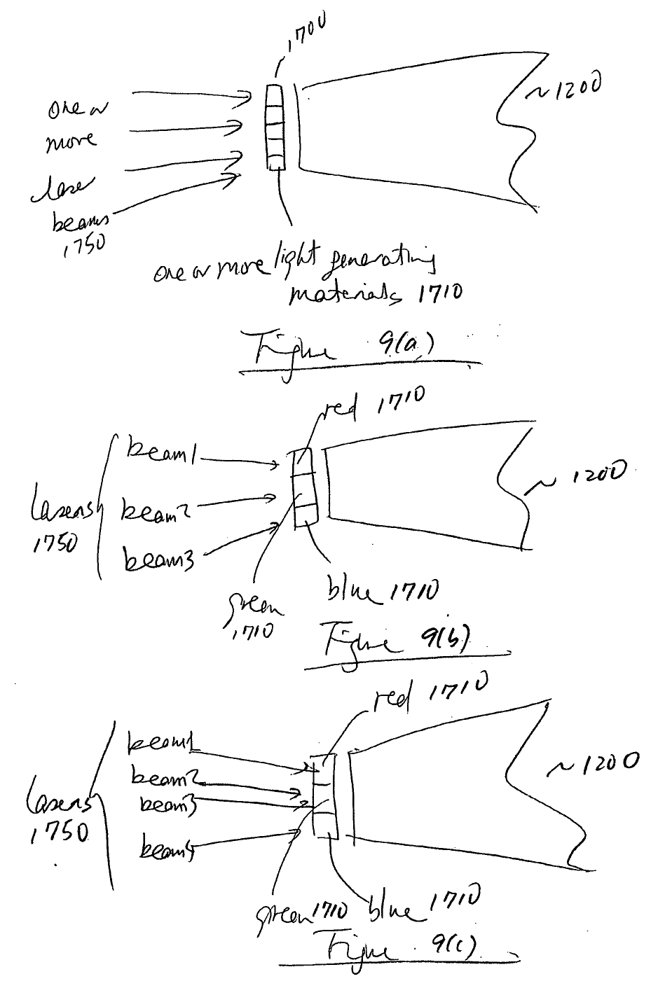

In accordance with an exemplary embodiment of the present invention, as shown in FIG. 9(a), one or more lasers 1750 can be used to excite one or more different light generating materials 1710 of the light generating layer 1700. For example in FIG. 9(b), three different lasers 1750 can be used, each laser 1750 exciting a different light generating material 1710, thereby enabling light multiplexer and recycler 1000 to independently control the emission of three different colors from the light generating layer 1700. In accordance with an aspect of the present invention, more than one laser 1750 can be used to excite the same light generating material 1710, thereby producing a higher light output from that light generating material. For example, in FIG. 9(c), the red and blue light generating materials 1710 are each excited by one laser 1750, but the green light generating material 1710 is excited by two laser, thereby producing more green light than either blue or red light by the light generating layer 1700.

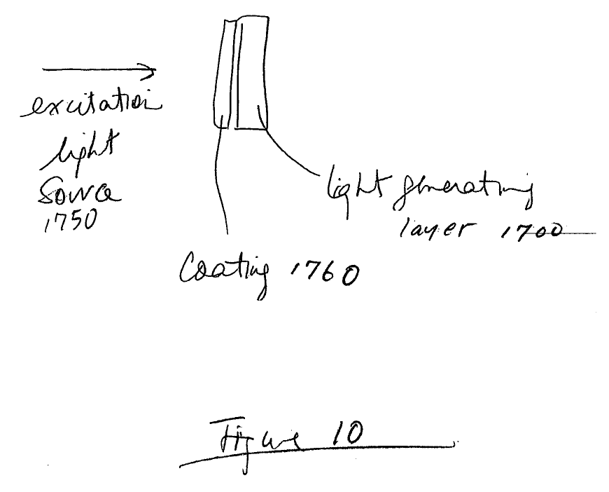

In accordance with an exemplary embodiment of the present invention, as shown in FIG. 10, the light generating layer 1700 is coated such that the coating 1760 transmits the light from the excitation light source 1750, but reflects the light generated by the light generating layer 1700 such that the generated light is emitted in only one direction, thereby increasing the efficiency of the light generating layer 1700 and the light multiplexer and recycler 1000 of the present invention. Preferably, the surface of the light generating layer 1700 near the excitation light source 1750 is coated.

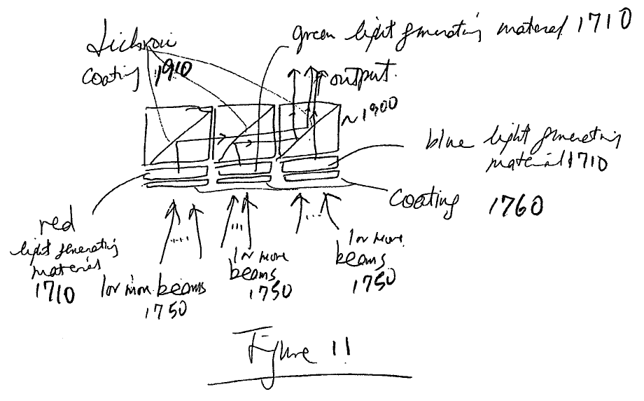

In accordance with an exemplary embodiment of the present invention, laser beams from three different lasers 1750 are used to excite three different light generating materials 1710 (red, green and blue light generating materials 1710). The light emitted from the three light generating materials 1710 are multiplexed into a single output using three total internal reflection (TIR) prisms or cubes 1900, as shown in FIG. 11. Since laser beams have a very narrow emission angle, each colored light generating material 1710 can be excited by more than one laser beam, thereby producing higher light output. For example, if a higher output of green light is needed for white balance, then two laser beams can be directed to the green light generating material 1710 while directed only one laser beam each to the blue and red light generating material, thereby producing higher output of green light.

In accordance with an aspect of the present invention, the TIR cube prism cube 1900 comprises two triangular prisms. All surfaces or faces of the two triangular prisms are polished such that the TIR cube prism 1900 act as a waveguide. The faces of the triangular prisms at the interface between the two triangular prisms are coated with dichoric coating 1910 to transmit a predetermined wavelength or color of light and reflect all other wavelengths or colors of light. Preferably, the interface is filled with air gap or low index glue.

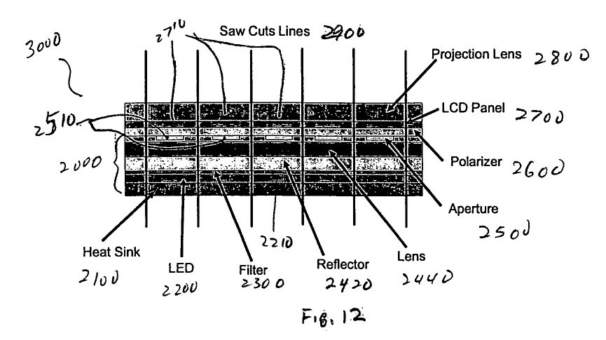

Turning now to FIGS. 12-14, there is illustrated a schematic diagram of the wafer scale illumination systems 2000 and/or wafer scale projector systems 3000 in accordance with an exemplary embodiment of the present invention. The wafer scale illumination systems 2000 comprises a heat sink layer 2100 for mounting the LED wafer or layer 2200, an optional filter layer 2300, preferably a colored filter layer 2300, an optics layer 2400, and an aperture layer 2500. The wafer scale projector systems 3000 additionally includes a reflective polarization layer 2600, an imaging or display panel layer 2700, such as liquid crystal display (LCD) panel layer or transmissive imaging panel layer, and a projections lens layer 2800. Current technology allows the LEDs to be made with the same color, but different colored LEDs 2210 can be made on the same wafer using colored phosphors in accordance with an exemplary embodiment of the present invention. Emissions from the same colored LEDs 2210 can be transformed into several other colors using colored phosphors. For example, a blue or UV LED wafer can be used to provide a plurality of LEDs 2210 of single color. Different colored phosphors can be deposited on the LED wafer, thereby producing different colored LEDs 2210. That is, three primary colors (red, green and blue) emitting LEDs 2210 can be produced using red, green, and blue phosphors.

Preferably, the colored filter layer 2300 is placed on the LED layer 2200 comprising a colored LEDs 2210 to improve the recycling efficiency of the wafer scale illumination system 2000. The colored filter on top of a colored LED 2210 transmits only the color of light emitted by the LED 2210 and reflects all other color of light. For example, the colored filter on top of the blue LED 2210 will transmit only blue light and will reflect all other color of light. For white or single color LED applications, the filter layer 2300 is not necessary and can be removed.

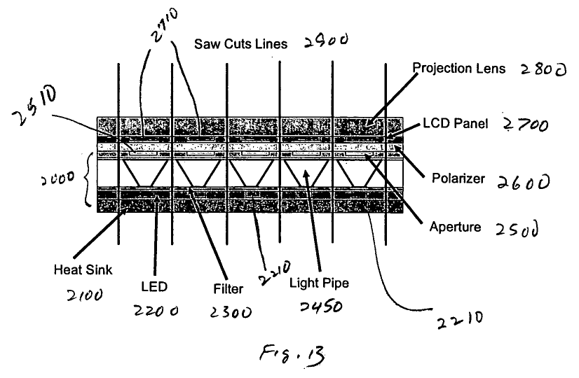

The optics layer 2400 transforms or images the light onto the subsequent layers. In accordance with exemplary embodiment of the present invention, as shown in FIG. 12, the optics layer 2400 comprises a reflector layer 2420 and a lens layer 2440. Depending on the application, the optics layer 2400 can comprise an array of light pipes 2450, as shown in FIG. 13, or spherical reflector layer 2460 and a collimating lens layer 2480. It is appreciated that depending on the application, the wafer scale illumination systems 2000 and the wafer scale projector systems 3000 can have multiple optics layers 2400.

In accordance with an exemplary embodiment of the present invention, the light pipe 2450 can be one of the following: hollow light pipe, solid light pipe, straight light pipe, increasingly tapered light pipe, decreasingly tapered light pipe, compound parabolic concentrator, free form light pipe with its shape defined by equations, or totally free-form light pipe determined numerically or other means, or any suitable combination, such as straight hollow light pipe, a increasingly tapered solid light pipe. All of these various light pipes will be collectively referred to herein as the light pipe. Any reference to a light pipe includes any of the light pipes or combination of various light pipes set forth herein.

The light exiting the optical layer 2400 is then incident on the aperture layer 2500 comprising a plurality of apertures or transmissive openings 2510 where part of the light is reflected and part of the light passes through the aperture 2510. The reflected light is recycled back in the LEDs 2210. The light exiting through the aperture 2510 is unpolarized light output which can be utilized for unpolarized applications, such as to provide a wafer scale illumination systems 2000.

For LCD, liquid crystal on silicon (LCOS), and other polarized light applications, such as to provide a wafer scale projection systems 3000, an optional reflective polarization layer 2600 is utilized. Preferably, the reflective polarization layer 2600 includes a wave plate layer (not shown) similar to the wave plate 1550 in FIG. 1. The reflective polarization layer or reflective polarizer 2600 transmits a predetermined polarization and reflects all other polarization of light (i.e., the unused polarization of light) back into the LED layer 2200, thereby increasing the effect of recycling. The optional wave plate layer rotates the polarization state of the light output and converts the unused polarization of light into the useful, predetermined polarization of light. At this stage, the composite wafer comprising illumination layers 2100-2600 (with or without the optional filter layer 2300, optional reflective polarization layer 2600, or the optional wave plate layer) forms an array of LED illumination systems 2000. The array of LED illumination systems 2000 can be cut on the saw cut lines 2900 into individual pieces to provide a plurality of separate LED illumination system 2000.

In accordance with an exemplary embodiment of the present invention, the wafer scale illumination systems 2000 can be further integrated with other layers to provide wafer scale projector systems 3000. The wafer scale projector systems 3000 further comprises a display or imaging panel layer 2700 which is placed on the top of the illumination layers 2100-2600 followed by one or more the projection lens layer 2800. FIG. 12 shows wafer scale projector systems 2000 where the imaging panel layer comprises transmissive LCD panels 2710 in accordance with an exemplary embodiment of the present invention. For a colored pixel LCD panel 2710, the LED 2210 can be white LEDs 2210 with white phosphor, or can be red/green/blue (RGB) LEDs 2210 combined together with the capability of adjusting the color in real time. For a fast switching LCD panel 2700, the wafer scale projector systems 3000 can utilize known time color multiplexing to turn on one or more of the red, green, blue LEDs 2210 at a time. Again, the completed projector units/systems 3000 in the wafer can be cut on the saw cut lines 2900 into individual projector units/systems 3000.

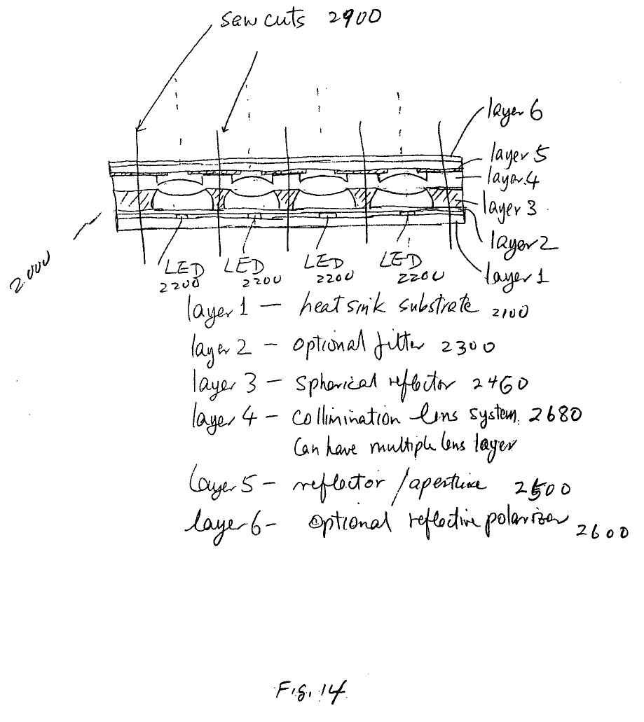

The implementation of the wafer scale projection systems using light pipes is shown in FIG. 13 and similarly, the imaging panel layer 2700 and a projections lens layer 2800 can be added to the illumination layers 2100-2600 in FIG. 14 to provide the wafer scale projection systems.

For embedded micro-projectors as used in portable electronic devices, such as the cell phones, MP3 players, portable digital assistants (PDAs), and the like, the most important parameters are size and cost. Accordingly, it is important to minimize the number of components in these embedded micro-projectors to reduce their size and cost. In accordance with an exemplary embodiment of the present invention, the micro-projector utilizes multiple LEDs, namely red, green, and blue LEDs on a single package. The light output from the multiple LEDs are multiplexed to combine the colors, recycled to increased brightness of the LEDs, and coupled to the LCOS panel without lenses, thereby minimizing the number of components.

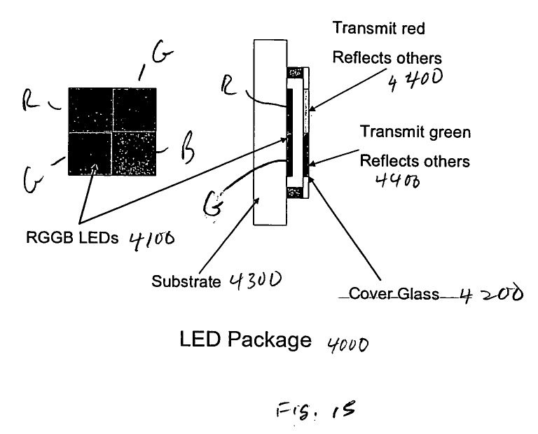

Turning now to FIG. 15, there is illustrated a structure of the LED package 4000 comprising a plurality of LEDs 4100. Preferably, the LED package 4000 consists of one red, one blue, and two green LEDs 4100, commonly supplied by LED manufacturers like Osram. In accordance with an exemplary embodiment of the present invention, the LED package 4000 has a cover window or glass 4200, which is preferably coated with dichroic coating 4400, and a substrate 4300 for mounting the plurality of LEDs 4100. For example, on top of the red LED 4100, the coating 4400 transmits red light and reflects all other colors of light, as shown in FIG. 15. On top of the green LED 4100, the coating 4400 transmits green light and reflects all other colors of light, as shown in FIG. 15. On top of the blue LED 4100, the coating 4400 transmits blue light and reflects other colors of light (not shown). In accordance with an exemplary embodiment of the present invention, each colored LED 4100 is driven independently. Optionally, the two green LEDs 4100 can be driven together or separately.

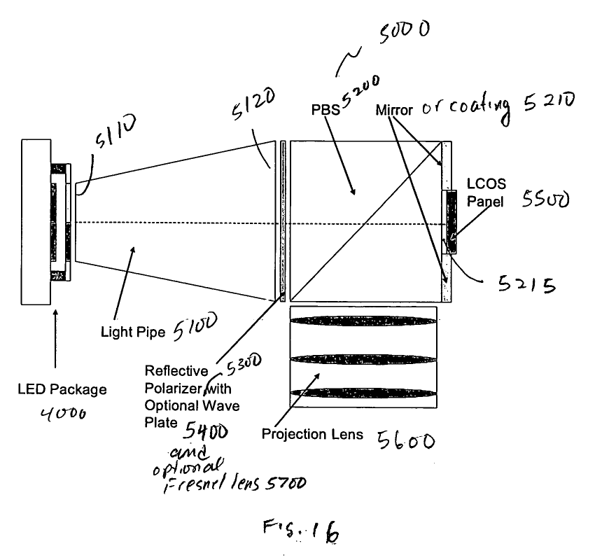

FIG. 16 shows a micro-projector 5000 incorporating the LED structure 4000 in accordance with an exemplary embodiment of the present invention. The micro-projector 5000 in accordance with an exemplary embodiment of the present invention comprises the LED package 4000, a light pipe 5100, a PBS 5200, a projection lens 5600, a LCOS panel 5500, an optional reflective polarizer 5300, and an optional wave plate 5400. The light pipe 5100 with input end or face 5110 substantially covers all the LEDs 4100 of the LED package 4000, is placed on the cover window 4200 package window and is used to coupled light emitted from the LEDs 4100. In accordance with an exemplary embodiment of the present invention, the light pipe 5100 can be one of the following: hollow light pipe, solid light pipe, straight light pipe, increasingly tapered light pipe, decreasingly tapered light pipe, compound parabolic concentrator, free form light pipe with its shape defined by equations, or totally free-form light pipe determined numerically or other means, or any suitable combination, such as straight hollow light pipe, a increasingly tapered solid light pipe. All of these various light pipes will be collectively referred to herein as the light pipe 1200. Any reference to a light pipe includes any of the light pipes or combination of various light pipes set forth herein.

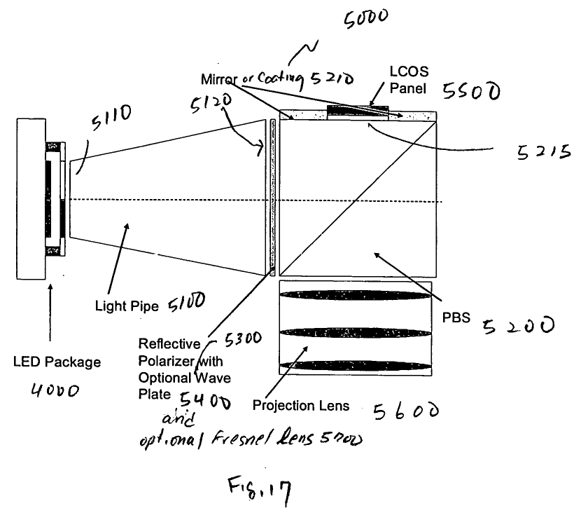

The output end 5120 of the light pipe 5100 has substantially the same size as the polarization beam splitter (PBS) 5200, couples light into the PBS 5200. The PBS 5200 has all surfaces polished so that it acts as a waveguide. Between the light pipe 5100 and the PBS 5200, a reflective polarizer 5300 is placed so that only the a predetermined polarization of light is transmitted into the PBS 5200. Between the light pipe 5100 and the reflective polarizer 5300, an optional wave plate 5400, preferably a quarter wave plate, can used to increase the recycling efficiency of the system. As shown in FIG. 16, the LCOS panel 5500 is placed directly opposite the light pipe 5100. Depending on the orientation of the PBS 5200, the LCOS panel 5500 can be placed on the perpendicular face as shown in FIG. 17. The projection lens 5600 can be placed perpendicular to the light pipe as shown in FIG. 16 or FIG. 17. Since the light incidence on the LCOS panel 5500 has a certain divergence, commonly at F/2.4, the PBS 5200 is larger than the LCOS panel 5500 so that the light is captured by the projection lens 5600 without blocking by the PBS 5200. The LCOS panel 5500 is placed as close to the PBS 5200 as possible so as to minimize losses. The surface of the PBS 5200 facing the LCOS panel 5500 is coated with reflective coating 5210 with an opening 5215 such that the size of the opening 5215 matches with the size of the LCOS panel 5500. As a result, a portion or part of the light will be illuminating the LCOS panel 5500, and the remaining portion or rest of the light incident on the reflective coating 5210 is reflected back into the light pipe 5100 and recycled back into LED package 4000.

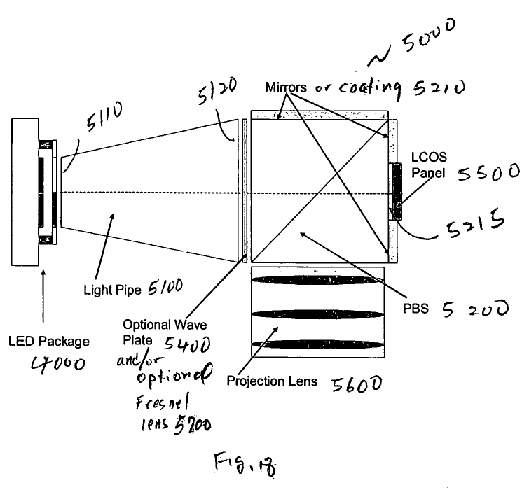

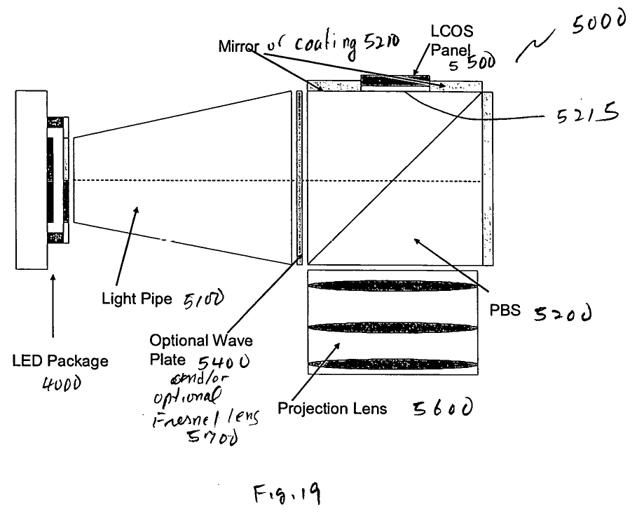

In accordance with an exemplary embodiment of the present invention, as shown in FIGS. 18, 19, the reflective polarizer 5300 in FIGS. 16, 17 can be eliminated and its function can be replaced by the combination of the PBS 5200 and the added reflective coating 5210 on the PBS as shown in FIGS. 18, 19. This advantageously eliminates one more component from the micro-projector, thereby reducing the cost of the micro-projector.

In accordance with an exemplary embodiment of the present invention, the output end 5120 of the light pipe 5100 can be made convex for improved coupling of light. Preferably, the convex surface of the output end 5120 of the light pipe 5100 forms an integrated lens. In accordance with an aspect of the present invention, the function of the integrated lens can be performed by an optional Fresnel lens 5700 disposed between the light pipe 5100 and the PBS 5200. The advantage of a Fresnel lens 5700 is that it is very thin and highly suitable for the integrated micro-projector of present invention. The focal length of the Fresnel lens 5700 or integrated lens is preferably adjusted for maximum performance.

In accordance with an exemplary embodiment of the present invention, the micro-projector 5000 can additionally comprise the color filter as described herein, which is placed on the cover glass 4200 of the LED package 4000. Alternatively, as described herein with the light multiplexer and recycler 1000, the color filter 4400 can be coated on the input face or end 5110 of the light pipe 5100. This preferably makes the cover glass 4200 optional, thereby eliminating another component from the micro-projector 5000.

Although the LED package 4000 described herein is a RGGB LED package, the LED package 4000 can comprise a plurality of LEDs 4100 or any M×N array of colored LEDs 4100, both M and N being a positive integer. In accordance with an exemplary embodiment of the present invention, each color LED 4100 can comprise one or more LEDs places strategically so that the color filters can be made easily. That is, each color can be made from several small LEDs place next to each other. Thus, in accordance with an exemplary embodiment of the present invention, each cluster of LEDs of the same color can be treated as a single LED.

It is appreciated that number of colors is not limited to three (red, green and blue) as discussed herein. The micro-projector of the present invention can be implemented using a LED package comprising LEDs of a single color, two colors, three colors, or more than three colors.

In accordance with an exemplary embodiment of the present invention, all surfaces of the PBS 5200 are polished. Certain surfaces of the PBS 5200 are for transmission and total internal reflection (TIR) and other surfaces are used only for TIR. Preferably, these TIR only surfaces of the PBS 5200 can optionally be coated with reflective coatings for ease of assembly.

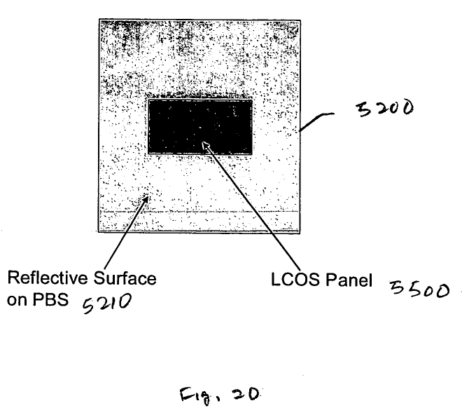

Turning now to FIG. 20, there is illustrated a view of the PBS 5200 from the direction of the LCOS panel 5500 showing that the LCOS panel 5500 only uses part of the PBS face. The rest of the PBS face is made reflective or has a reflective coating 5210 for recycling purposes.

In accordance with an exemplary embodiment of the present invention, the micro-projector 5000 utilizes the LED package 4000 comprising only white LEDs 4100 instead of the RGGB LED 4100. As a result, the coating 4400 on the LED package can be eliminated. The micro-projector 5000 comprises a white LED 4100, a light pipe 5100, a PBS 5200. If a standard LCOS panel 5500 is used as shown in the FIGS. 16-19, the output will be a black and white picture projected onto a screen (not shown). Preferable, a color pixel LCOS can be used instead of stand LCOS panel for producing color pictures. The color pixel LCOS can be made with transparent color filtered placed on top of the pixels such that part of the pixels are red, part of the pixels are green, and part of the pixels are blue. In accordance with an aspect of the present invention, the part of the pixels are not colored and are considered to be white pixels, thereby enhancing the brightness of the display. Although the color pixel LCOS simplifies the construction, the resolution can be smaller. For certain applications, lower resolution made be acceptable if it lowers the complexity of the micro-projector, thereby lowering the cost of the micro-projector.

In accordance with an exemplary embodiment of the present invention, the micro-projector 5000 incorporates a digital mirror device (DMD) 5910, similar to the digital light processing (DLP®) device made by Texas Instruments. The DMD 5910 is preferably mounted on a DMD package 5900. The DMD 5910 has many small mirrors (pixels), which can be tilted. When the light ray (a) is incident onto the DMD 5910 with the pixel turned off, the light is reflected away from the incident direction and away from the projection lens 5600 and will not be projected onto the screen (not shown). When the pixel is turned on, the mirrors of the DMD 5910 tilts towards the incident beam and the reflected light is directed towards the projection lens 5600 and is projected onto the screen. The TIR cube prism 5800 comprises two triangular prisms 5810, 5820 in which the first triangular prism 5810 provides the incident beam to the DMD 5910 in which the incident beam is reflected by total internal reflection. The reflected beam from the DMD 5910 is not reflected, but transmitted through the interface, and to the second triangular prism 5820. The two triangular prisms 5810, 5820 forms parallel interfaces such that the image from the DMD 5910 will not be distorted.

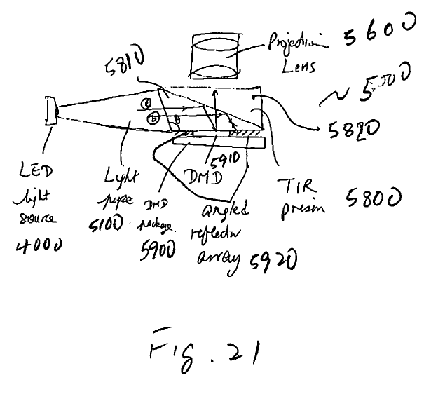

All the faces of the first triangular prism 5810 (and preferably, all the faces of the second triangular prism 5820) are polished such that it forms a waveguide. The angle theta (θ) is adjusted for maximum efficiency. Since the light incidence onto the DMD 5910 has a certain numerical aperture, the size of the TIR prism 5800 is larger than the imaging area of the DMD, as shown in FIG. 21. The light guided onto the TIR prism 5800 at the DMD surface is larger, and if the light is not collected, then the light will be normally lost. Accordingly, in accordance with an exemplary embodiment of the present invention, the area outside the imaging area on the TIR prism 5800 is covered with a reflecting structure 5920. Preferably, the reflecting structure 5920 is an angled mirror array, angled reflector array, angled array of mirrors, gratings, or retro-reflector array, such that the light incident on the angled mirror array 5920 is reflected back into the incident direction as shown as a ray (b) in FIG. 21. The angled mirror array 5920 can be made with spacing that is determined by how thick it can be. The limitation is usually due to the space between the TIR prism 5800 and the DMD package 5900. The reflected light eventually travels back through the light pipe 5100 and back into the LEDs 4100.

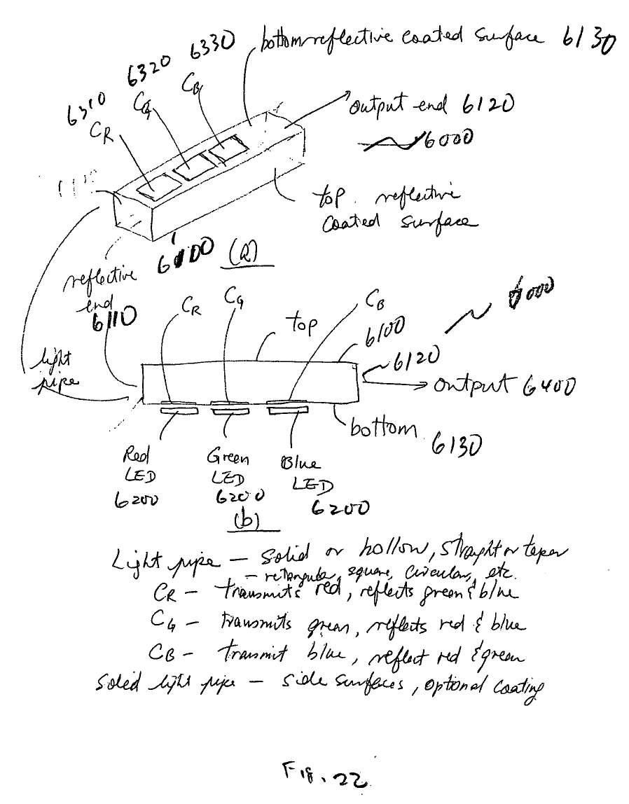

Turning now to FIGS. 22(a)-(b), there is illustrated a light multiplexer and recycler 6000 in accordance with an exemplary embodiment of the present invention. The light multiplexer and recycler 6000 comprises a light pipe 6100. The cross-section of the light pipe 6100 can be rectangular, square, circular, etc. In accordance with an exemplary embodiment of the present invention, the light pipe 6100 can be one of the following: hollow light pipe, solid light pipe, straight light pipe, increasingly tapered light pipe, decreasingly tapered light pipe, compound parabolic concentrator, free form light pipe with its shape defined by equations, or totally free-form light pipe determined numerically or other means, or any suitable combination, such as straight hollow light pipe, a increasingly tapered solid light pipe. All of these various light pipes will be collectively referred to herein as the light pipe 1200. Any reference to a light pipe includes any of the light pipes or combination of various light pipes set forth herein.

The top, bottom, and left surfaces of the light pipe 6100 are reflective coated with the output end 6120 to the right. As shown in FIG. 22(a), the bottom surface 6130 facing up has three openings for the LED chips 6200. The red chip 6200 is placed at the red window 6310 with CR coating, which transmits red light and reflects green and blue light. The green chip 6200 is placed at the green window 6320 with CG coating, which transmits green light and reflects red and blue light. The blue chip 6200 is place at the blue window 6330 with CB coating, which transmits blue light and reflects red and green light. The sidewalls of the light pipe can be optionally coated as total internal reflection can be used intrinsically. As a result, the light from the red chip 6200 does not see the green or the blue chips 6200 due to the red reflecting window 6310. The same is true for the light from the green and blue chips 6200.

Accordingly, each color forms its own recycling system and all the colors are mixed in the same light pipe 6100 and produces a multiplexed output 6400.

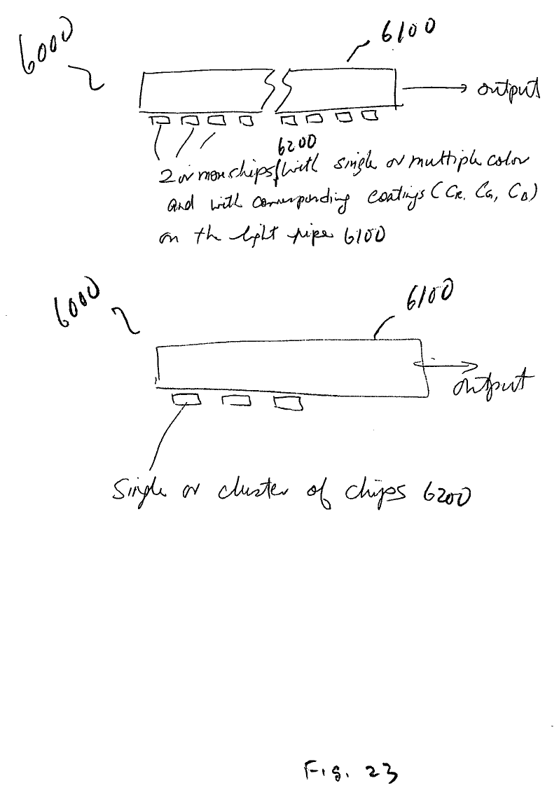

Although FIGS. 22(a)-(b), shows the configuration using red, green, and blue LED chips 6200, the general arrangement can consists of two or more chips with one or more colors as shown in FIG. 23. Corresponding coatings are used that matches each color of the LED chips 6200. For example, two or more chips 6200 of the same color can be used with the coated windows 6310, 6320, 6330 of the same type. Depending on the relative intensity of the different colors required in a particular application, an appropriate number of chips can be utilized. The LED chips 6200 are shown as single LED chips 6200 in FIGS. 22-23, can also be made up of multiple chips of the same color with several chips clustered together in an array form. Minimum spaces between these chips are preferred.

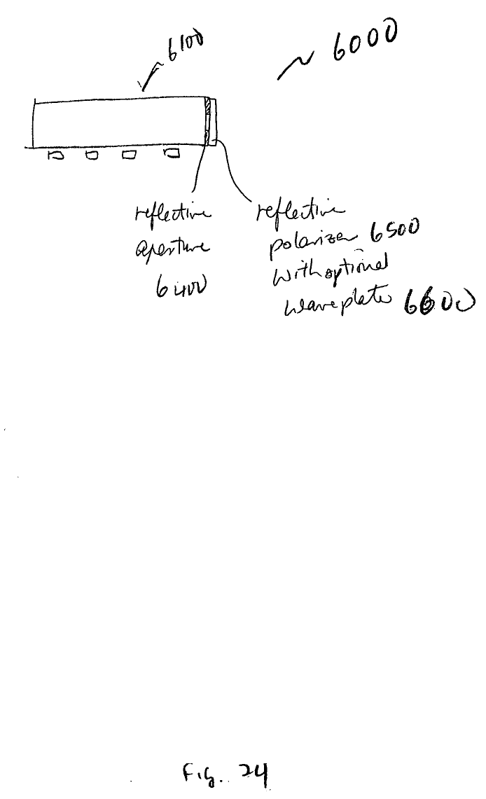

In accordance with an exemplary embodiment of the present invention, as shown in FIG. 24, the light multiplexer and recycler 6000 additionally comprises an output reflective aperture with an opening appropriate for a particular application at the output end 6120 of the light pipe 6100, thereby providing additional recycling. For polarized light applications, a reflective polarizer 6500 and an optional wave plate 6600 can be added. Descriptions of the reflective coating or aperture, reflective polarizer and optional wave plate as set forth herein in connection with other exemplary embodiments of the present invention are equally applicable and will not set forth again herein.

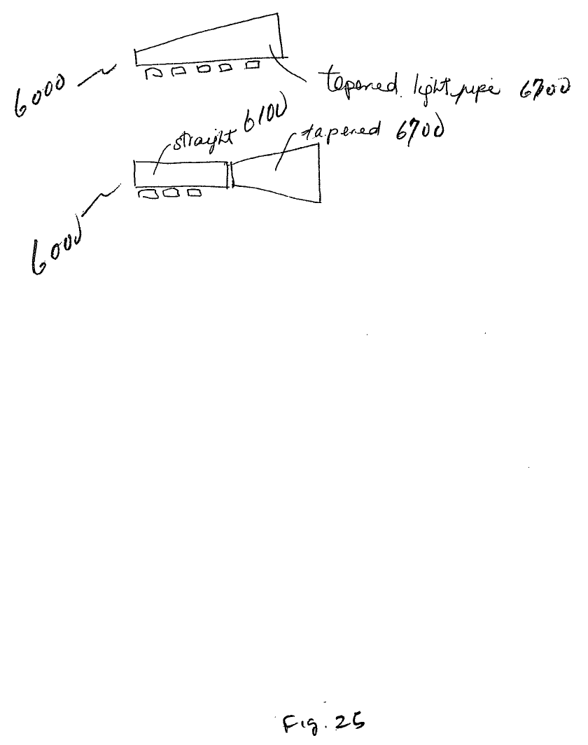

In accordance with an exemplary embodiment of the present invention, as shown in FIG. 25, the light multiplexer and recycler 6000 comprises a tapered light pipe 6700 either integrated with the recycling/multiplexing light pipe 6100, or as a separate light pipe 6700 for transforming the output to the desired size and angle.

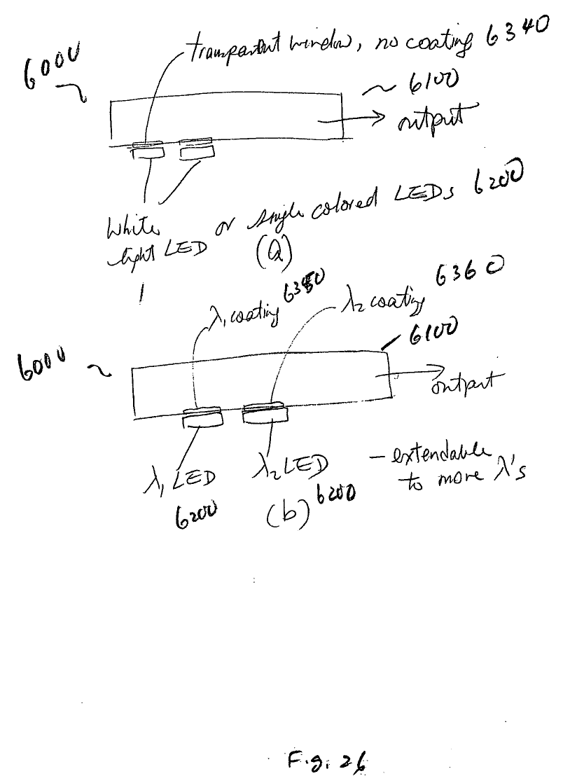

In accordance with an exemplary embodiment of the present invention, as shown in FIG. 26(a), the light multiplexer and recycler or system 6000 using white LEDs 6200 in which the window 6340 has no coating. When singled colored LEDs 6200 are used, clear windows 6200 with no coating can also be used, as shown in FIG. 26(a).

In accordance with an embodiment of the present invention, as shown in FIG. 26(b), two LEDs with wavelengths very closed to each other can be used to increase the brightness of the system 6000 as they can be multiplexed together using coating windows 6350, 6360. For example, this embodiment can be used with two or more green chips 6200 where their wavelengths are close enough to be considered as green.

The invention, having been described, it will be apparent to those skilled in the art that the same may be varied in many ways without departing from the spirit and scope of the invention. Any and all such modifications are intended to be included within the scope of the following claims.

What is claimed is:

1. A light multiplexer and recycler, comprising:
a LED layer comprising a plurality of LEDs, each emitting a light output;
an optics layer having an input end and an output end, said input end of said optics layer being coupled to said plurality of LEDs for multiplexing light output from said plurality of LEDs; and
an aperture layer coupled to said output end of said optics layer and having a transmissive opening for transmitting a portion of the multiplexed light output to provide a single light output and a reflective surface for reflecting remaining portion of the multiplexed light toward said input end of said optics layer, thereby recycling the remaining portion of the multiplexed light back to said plurality of LEDs to increase the brightness of the light output of said plurality of LEDs.

2. The light multiplexer and recycler of claim 1, wherein said optics layer comprises a lens layer for transmitting a portion of light output from said plurality of LEDs to said aperture layer and a reflective layer for reflecting a remaining portion of light output from said plurality of LEDs back to said plurality of LEDs for recycling.

3. The light multiplexer and recycler of claim 1, wherein said optics layer comprises a light pipe for transmitting a portion of light output from said plurality of LEDs to said aperture layer and reflecting a remaining portion of light output from said plurality of LEDs back to said plurality of LEDs for recycling.

4. The light multiplexer and recycler of claim 1, wherein said optics layer comprises lenses for transmitting a portion of light output from said plurality of LEDs to said aperture layer and a spherical reflector for reflecting a remaining portion of light output from said plurality of LEDs back to said plurality of LEDs for recycling.

5. The light multiplexer and recycler of claim 3, further comprising a reflective layer covering said input end of said light pipe except areas of said input end where said plurality of LEDs are coupled.

6. The light multiplexer and recycler of claim 5, wherein said reflective layer is a reflective coating on said input end of said light pipe except areas of said input end where said plurality of LEDs are coupled.

7. The light multiplexer and recycler of claim 5, further comprising a glass plate selectively coated with a reflective coating to cover said input end of said light pipe except areas of said input end where said plurality of LEDs are coupled.

8. The light multiplexer and recycler of claim 1, wherein said transmissive opening has aspect ratio of 16:9 or 4:3.

9. The light multiplexer and recycler of claim 1, wherein said plurality of LEDs are arranged in a M×N array, where both M and N are positive integers.

10. The light multiplexer and recycler of claim 1, further comprising a heat sink for mounting said plurality of LEDs.

11. A micro-projector, comprising:
a LED layer comprising a LED emitting a light output;
a light pipe having an input end and an output end, said input end of said light pipe being coupled to LED;
an aperture layer coupled to said output end of said light pipe and having a transmissive opening for transmitting a portion of the light output and a reflective surface for reflecting remaining portion of the light output toward said input end of said light pipe, thereby recycling the remaining portion of the light output back to said LED to increase the brightness of the light output of said LED;
a reflective polarizer disposed between said light pipe and said aperture layer for transmitting said light output of a predetermined polarization and reflecting other polarization of said light output, thereby recycling unused polarization of said light output back to said LED to increase the brightness of said light output of said LED;
a liquid crystal on silicon (LCOS) panel for receiving and reflecting said light output of a predetermined polarization, wherein size of said transmissive opening substantially matches size of said LCOS panel such that a face of said PBS coupling said LCOS panel is larger than said LCOS panel; and
a projection lens for capturing said light output of said predetermined polarization from said LCOS panel to project an image.

12. The micro-projector of claim 11, wherein said light pipe is at least one of the following: straight light pipe, hollow light pipe, solid light pipe, increasingly tapered light pipe, decreasingly tapered light pipe, compound parabolic concentrator, and free form light pipe.

13. The micro-projector of claim 11, further comprising a wave plate for rotating a polarization state of said light output and converting said unused polarization of light reflected by said reflective polarizer into said predetermined polarization of light.

14. The micro-projector of claim 11, wherein said aperture layer is a polarization beam splitter (PBS) with all surfaces polished to provide total internal reflection such that said PBS acts as a waveguide; and wherein a face of said PBS coupling said light pipe has a size substantially equal to said output end of said light pipe.

15. The micro-projector of claim 11, wherein said LCOS panel is disposed opposite said output end of said light pipe or perpendicular to said light pipe.

16. The micro-projector of claim 14, wherein said output end of said light pipe has a convex surface and forms an integrated lens.

17. The micro-projector of claim 14, further comprising a Fresnel lens disposed between said light pipe and said PBS.

18. The micro-projector of claim 11, wherein said LED is a white LED; and wherein said LCOS panel is a color pixel LCOS.

19. The micro-projector of claim 18, wherein said color pixel LCOS comprises a transparent color filter to provide a plurality of red, green and blue pixels.

20. The micro-projector of claim 11, wherein said LED layer is a LED package comprising an array of colored LEDs; and further comprising a reflective layer covering said array of colored LEDs.

21. The micro-projector of claim 20, wherein said reflective layer is coated with dichroic coating such that an area of said reflective layer covering a colored LED transmits a color of light emitted by said colored LED and reflects all other color of light back to said colored LED for recycling.

22. The micro-projector of claim 20, wherein said reflective layer is a dichroic coating on said input end of said light pipe such that an area of said reflective layer on said input end of said light pipe coupled to a colored LED transmits a color of light emitted by said colored LED and reflects all other color of light back to said colored LED for recycling.

23. The micro-projector of claim 20, wherein said LED package comprises an array of blue, green and red LEDs.

24. The micro-projector of claim 23, wherein said LED package comprises an array of at least one red LED, one blue LED and one red LED.

25. The micro-projector of claim 24, wherein said LED package comprises an array of at least one red LED, one blue LED and two green LEDs.

26. The micro-projector of claim 11, wherein said LED comprises a cluster of LEDs of same color packed tightly together.

27. A micro-projector, comprising:
a LED layer comprising a LED emitting a light output;
a light pipe having an input end and an output end, said input end of said light pipe being coupled to LED;
a polarization beam splitter (PBS) with all surfaces polished to provide total internal reflection such that said PBS acts as a waveguide, said PBS being coupled to said output end of said light pipe and having a transmissive opening, wherein a face of said PBS coupling said light pipe has a size substantially equal to said output end of said light pipe;
a liquid crystal on silicon (LCOS) panel for receiving and reflecting said light output of a predetermined polarization, wherein size of said transmissive opening substantially matches size of said LCOS panel such that a face of said PBS coupling said LCOS panel is larger than said LCOS panel; and
a projection lens coupled to a face of said PBS for capturing said light output of said predetermined polarization from said LCOS panel to project an image; and
wherein all faces of said PBS has a reflective coating except said face coupled said projection lens and said transmissive opening to transmit a portion of said light output through said transmissive opening, and reflect and recycle remaining portion of said light output back to said LED to increase the brightness of the light output of said LED.

28. The micro-projector of claim 27, wherein said light pipe is at least one of the following: straight light pipe, hollow light pipe, solid light pipe, increasingly tapered light pipe, decreasingly tapered light pipe, compound parabolic concentrator, and free form light pipe.

29. The micro-projector of claim 27, further comprising a wave plate disposed between said light pipe and said PBS for rotating a polarization state of said light output and converting said unused polarization of light reflected by said reflective polarizer into said predetermined polarization of light.

30. The micro-projector of claim 27, wherein said LCOS panel is disposed opposite said output end of said light pipe or perpendicular to said light pipe.

31. The micro-projector of claim 27, wherein said output end of said light pipe has a convex surface and forms an integrated lens.

32. The micro-projector of claim 27, further comprising a Fresnel lens disposed between said light pipe and said PBS.

33. The micro-projector of claim 27, wherein said LED is a white LED; and wherein said LCOS panel is a color pixel LCOS.

34. The micro-projector of claim 33, wherein said color pixel LCOS comprises a transparent color filter to provide a plurality of red, green and blue pixels.

35. The micro-projector of claim 27, wherein said LED layer is a LED package comprising an array of colored LEDs; and further comprising a reflective layer covering said array of colored LEDs.

36. The micro-projector of claim 35, wherein said reflective layer is coated with dichroic coating such that an area of said reflective layer covering a colored LED transmits a color of light emitted by said colored LED and reflects all other color of light back to said colored LED for recycling.

37. The micro-projector of claim 35, wherein said reflective layer is a dichroic coating on said input end of said light pipe such that an area of said reflective layer on said input end of said light pipe coupled to a colored LED transmits a color of light emitted by said colored LED and reflects all other color of light back to said colored LED for recycling.

38. The micro-projector of claim 35, wherein said LED package comprises an array of blue, green and red LEDs.

39. The micro-projector of claim 38, wherein said LED package comprises an array of at least one red LED, one blue LED and one red LED.

40. The micro-projector of claim 39, wherein said LED package comprises an array of at least one red LED, one blue LED and two green LEDs.

41. The micro-projector of claim 27, wherein said LED comprises a cluster of LEDs of same color packed tightly together.

42. A micro-projector, comprising:
a LED layer comprising a LED emitting a light output;
a light pipe having an input end and an output end, said input end of said light pipe being coupled to LED;
a total internal reflection (TIR) cube prism comprising first and second triangular prisms, all faces of said first and second triangular prisms are polished to form a waveguide;
a digital mirror device (DMD) comprising a plurality of tiltable mirrors coupled to a face of said first triangular prism of said TIR cube prism to provide an imaging area, said face of said first triangular prism being larger than said imaging area and rays of said light output incident on said DMD;
a reflecting structure covering said face of said triangular prism outside said imaging area to reflect and recycle rays of said light output incident on said reflecting structure remaining portion of said light output back to said LED to increase the brightness of the light output of said LED; and
a projection lens coupled to a face of said second triangular prism for capturing said rays of light reflected from said DMD to project an image when said tiltable mirrors of said DMD is turned on.

43. The micro-projector of claim 42, wherein said light pipe is at least one of the following: straight light pipe, hollow light pipe, solid light pipe, increasingly tapered light pipe, decreasingly tapered light pipe, compound parabolic concentrator, and free form light pipe.

44. The micro-projector of claim 42, wherein spaces between said light pipe, said TIR cube prism, said DMD, and said projection lens are filled with air gaps or low index glue.

45. The micro-projector of claim 42, wherein said reflecting structure is one of the following: angled reflector array, angled array of mirrors, gratings, or retro-reflector array.

46. The micro-projector of claim 42, wherein said LED layer is a LED package comprising an array of colored LEDs; and further comprising a reflective layer covering said array of colored LEDs.

47. The micro-projector of claim 42, wherein said reflective layer is coated with dichroic coating such that an area of said reflective layer covering a colored LED transmits a color of light emitted by said colored LED and reflects all other color of light back to said colored LED for recycling.

48. The micro-projector of claim 42, wherein said reflective layer is a dichroic coating on said input end of said light pipe such that an area of said reflective layer on said input end of said light pipe coupled to a colored LED transmits a color of light emitted by said colored LED and reflects all other color of light back to said colored LED for recycling.

49. The micro-projector of claim 42, wherein said LED package comprises an array of blue, green and red LEDs.

50. The micro-projector of claim 49, wherein said LED package comprises an array of at least one red LED, one blue LED and one red LED.

51. The micro-projector of claim 50, wherein said LED package comprises an array of at least one red LED, one blue LED and two green LEDs.

52. The micro-projector of claim 42, wherein said LED comprises a cluster of LEDs of same color packed tightly together.

53. A light multiplexer and recycler, comprising:
a light generating layer for emitting rays of light when excited by a light source and having a reflective surface;
a light pipe having an input end and an output end, said input end of said light pipe being coupled to said light generating layer for multiplexing said rays of light from said light generating layer to provide a light output; and
an aperture layer coupled to said output end of said light pipe and having a transmissive opening for transmitting a portion of said light output and a reflective surface for reflecting remaining portion of said light output toward said light generating layer which reflects and recycles said remaining portion of light output back towards said transmissive opening.

54. The light multiplexer and recycler of claim 53, wherein said light generating layer comprises one or more type of compositions to emit said rays of light having a plurality of wavelengths or colors.

55. The light multiplexer and recycler of claim 54, wherein said one or more type of compositions are spatially distributed in said light generating layer such that each different area of said light generating layer emits said rays of light of different color.

56. The light multiplexer and recycler of claim 53, wherein said light source used for exciting said light generating layer is one of the following: arc lamp, LED or laser.

57. The light multiplexer and recycler of claim 53, wherein said light source emits rays of light of a first wavelength and said light generating layer emits said rays of light of a second wavelength, said first wavelength being shorter than said second wavelength.

58. The light multiplexer and recycler of claim 53, wherein said light source emits rays of light of a first wavelength and said light generating layer emits said rays of light of a second wavelength, said first wavelength being longer than said second wavelength.

59. The light multiplexer and recycler of claim 53, wherein said light generating layer is coated on said input end of said light pipe.

60. The light multiplexer and recycler of claim 53, further comprising a glass plate disposed in proximity to said input end of said light pipe, said light generating layer being coated on said glass plate.

61. The light multiplexer and recycler of claim 53, wherein said light generating layer is coated on said light source.

62. The light multiplexer and recycler of claim 53, further comprising a cavity formed by opposing reflecting layers for housing said light generating layer to reduce angular distribution of said rays of light emitted by said light generating layer.

63. The light multiplexer and recycler of claim 53, further comprising a cavity formed by opposing reflecting layers for housing said light generating layer and said light source to reduce angular distribution of said rays of light emitted by said light generating layer.

64. The light multiplexer and recycler of claim 56, wherein said laser is a diode laser.

65. The light multiplexer and recycler of claim 64, wherein said light generating layer comprises a red, green and blue light generating materials excited by said diode laser.

66. The light multiplexer and recycler of claim 64, wherein said light generating layer comprises a red, green and blue light generating materials, each light generating material excited by at least one diode laser.

67. The light multiplexer and recycler of claim 53, wherein said light generating layer is coated to transmit rays of light from said light source and reflect said rays of light emitted from said light generating layer, such that said light generating layer emits rays of light in one direction.

68. The light multiplexer and recycler of claim 67, further comprising three cube prism; and wherein said light generating layer comprises a red, green and blue light generating materials for respectively emitting red, green and blue rays of light, each light generating material excited by at least one diode laser and coupled to a different cube prism to multiplex said red, green and blue rays of light into a single light output of red.
